(19) United States
(12) Patent Application Publication
(10) Pub. No.: US 2026/0095775 A1
(43) Pub. Date: Apr. 2, 2026

(54) COVERAGE GAP DETECTION

(71) Applicant: T-Mobile Innovations LLC, Overland Park, KS (US)

(72) Inventor: Yinjun ZHU, Sammamish, WA (US)

(21) Appl. No.: 18/904,497

(22) Filed: Oct. 2, 2024

(51) Int. Cl. H04W 16/18

(52) U.S. Cl. CPC H04W 16/18

(57) ABSTRACT

Systems, methods and non-transitory computer-readable mediums are provided for coverage gap or coverage hole detection. Emergency call data is utilized to identify coverage holes based on a location of the radio tower utilized and the location of the wireless device making the emergency call. The distance between the two locations is further utilized to identify coverage holes by comparing the distance to a predetermined threshold and further by determining a number of times in a predetermined time period that a potential coverage hole is identified at the wireless device location.

### TECHNICAL BACKGROUND

Generally in wireless networks, such as fourth generation (4G) Long Term Evolution (LTE), fifth generation (5G) new radio (NR) networks, and sixth generation (6G) networks, multiple radio towers or base stations including access nodes such as evolved node Bs (eNodeBs or eNBs) and next generation nodeBs (gNodeBs or gNBs) may be deployed to maximize coverage of the wireless network. With the evolution of radio access technologies (RATs) and the rapid expansion of cellular networks to accommodate increasing wireless data demand, radio coverage analysis and coverage planning remain crucial and complex tasks when deploying a wireless network. Despite a very careful coverage planning during the deployment phase, the existence of coverage holes during the operational phase is a common and almost unavoidable problem that operators place a high priority on addressing.

For the purpose of coverage planning, it is necessary to detect the coverage holes in a process called coverage hole detection, and then deploy a solution that remedies the coverage problem in the uncovered zones. A goal is to achieve a deployed solution that is cost-efficient and well-performing. To achieve such a solution, network operators need the precise information conveying the location and shape of the coverage holes. Obtaining this information is referred to as coverage hole prediction. The effectiveness of the deployed solution highly depends on the performance of the detection and the prediction. Traditionally, the cellular coverage is computed using sophisticated planning tools, and then optimized through drive tests. Manual coverage detection and prediction through drive tests has proven to be an inefficient and costly task.

Despite efforts to maximize coverage, coverage gaps exist in every wireless network. The coverage gaps may be due to many different factors. For example, the coverage gaps may be due to interfering geographic features, such as tall buildings, tunnels, or large bodies of water. The coverage gaps may further be due to factors such as congestion and interference, for example in dense urban areas. Additionally, coverage gaps may be due to insufficient radio equipment, which occurs frequently in remote or rural areas.

Accordingly, an objective of wireless network operators is to automatically identify these existing coverage gaps in order to provide sufficient information to improve the coverage of the wireless network. The use of wireless coverage complaints during voice call or data usage has proven ineffective as precise location information is seldom readily available. In order to reliably detect coverage holes in order to improve wireless network service, a method for efficiently collecting and analyzing accurate data is required.

### Overview

Exemplary embodiments described herein include systems, methods, and processing nodes for identifying coverage gaps in wireless network. An exemplary method includes utilizing emergency call data to identify coverage gaps. The method includes identifying an initial location corresponding to the serving cell for an emergency call made by a wireless device and identifying an updated location for the emergency call made by the wireless device. The method further includes determining a distance between the initial location and the updated location, comparing the distance to a predetermined threshold, and locating a potential coverage gap when the distance meets the predetermined threshold.

Further embodiments include a system having a memory storing instructions and a processor accessing the memory and executing the instructions to perform multiple operations in order to use emergency call data to identify coverage gaps in a wireless network. The multiple operations include identifying an initial location corresponding to the serving cell for an emergency call made by a wireless device and identifying an updated location for the emergency call made by the wireless device. The operations additionally include determining a distance between the initial location and the updated location, comparing the distance to a predetermined threshold, and locating a potential coverage gap when the distance meets the predetermined threshold.

Additionally, embodiments include a non-transitory computer-readable medium storing instructions executed by a processor to perform multiple operations. The operations include identifying an initial location corresponding to the serving cell and an updated location for an emergency call made by a wireless device. The operations further include determining a distance between the initial location and the updated location, comparing the distance to a predetermined threshold, and locating a potential coverage gap when the distance meets the predetermined threshold.

### BRIEF DESCRIPTION OF THE DRAWINGS

FIG. 1 depicts an exemplary operating environment for coverage gap detection in accordance with the disclosed embodiments.

FIG. 2 is a workflow diagram illustrating operation of a coverage gap detection system in accordance with disclosed embodiments.

FIG. 3 illustrates a coverage gap detection system in accordance with disclosed embodiments.

FIG. 4 depicts an exemplary method for coverage gap detection in accordance with disclosed embodiments.

FIG. 5 depicts a further exemplary method for coverage gap detection in accordance with disclosed embodiments.

FIG. 6 depicts a further exemplary method for coverage gap detection in accordance with disclosed embodiments.

### DETAILED DESCRIPTION

Exemplary embodiments described herein include systems and methods for coverage gap detection utilizing emergency call data. Currently, for every emergency call in a wireless networks, multiple high accuracy locations are retrieved or pushed to a Gateway Mobile Location Center (GMLC). This applies to multiple types of emergency calls including, but not limited to global system for mobile communication (GSM), voice over LTE (VoLTE), voice over new radio (VoNR) or voice over Wireless fidelity (VoWiFi). The GMLC contains functionality required to support location-based service (LBS). The GMLC may perform registration authorization and may interact with other network entities to derive location estimates. Access to the GMLC is reliable as the GMLC is required by existing regulations. The GMLC acquires wireless device locations and therefore enable LBS, including emergency services. The GMLC further may route the emergency call to a Public Safety Answering Point (PSAP).

In accordance with embodiments provided herein, a coverage gap identification system interacts with the GMLC to utilize multiple locations that are logged for every emergency call. As emergency related data is required by regulatory agencies and is collected and stored for every emergency call, the proposed method is an efficient, accurate and low-cost method to automatically detect radio coverage gaps in an existing network. This method can tolerate any dynamic network changes, i.e. reports can be generated prior to and subsequent to network changes. First, an initial location is logged. This initial location may be, for example, the location of the serving cell or access node for the emergency call. The location of the serving cell may be identified, for example, by the latitude and longitude of the serving cell. The initial location is used by the GMLC to determine which public safety answering point (PSAP) handles the corresponding emergency call.

Additionally, an updated location is logged for each emergency call. The updated location is a precise location of the wireless device that initiated an emergency call. Depending on the type of radio technology (e.g. GSM, VOLTE or VoNR) that is used, and the mobile capability, control plane positioning procedure and/or user plane location may be involved to provide the precise location of the wireless device that initiated the emergency call. Various methods may be utilized to push this position to the GMLC. For example, position methods can include global positioning system (GPS), global navigation satellite system (GNSS) or device based hybrid (DBH) methods. DBH may be handled differently by different device manufacturers. In any case, DBH methods corroborate location information across multiple sources to increase accuracy.

Thus, in embodiments provided herein, the system and method for identifying coverage gaps can utilize the location data described and calculate a distance between the initial location (serving cell) and the most accurate updated location in a short time (e.g. 30 s) after an emergency initiated. After the distance between the initial location and the updated location are calculated, the distance is compared to a configurable threshold (e.g. seventy five kilometers). If multiple instances are found for the distance exceeding the threshold for a specific geodetic location within certain time period, then the specific location will be identified as a radio coverage hole or gap. The threshold may be adjusted based on the average radius or cell size for a specific market or area.

In addition to the systems and methods described herein, the operations for identifying coverage gaps may be implemented as computer-readable instructions or methods, and processing nodes on the network for executing the instructions or methods. The processing node may include a processor included in the access node or a processor included in any controller node in the wireless network that is coupled to the access node.

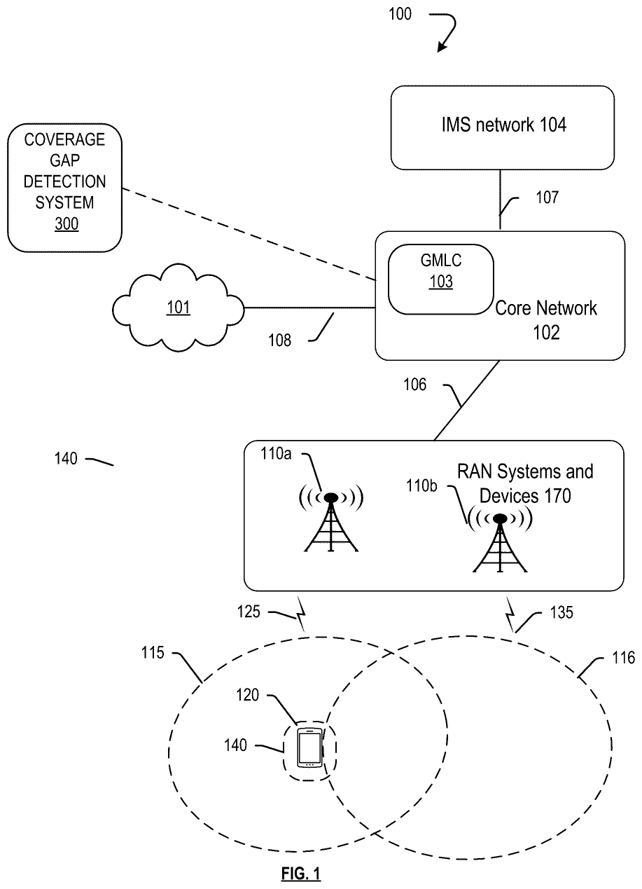

FIG. 1 depicts an exemplary environment 100 for a coverage gap detection system 300 in accordance with the disclosed embodiments. The environment 100 may include a communication network 101, a core network 102, an IMS network 104 and a radio access network (RAN) 170, including at least access nodes 110a and 110b. The core network 102 is connected to the communication network 101 over communication link 108 and to the IMS network 104 over the communication link 106. The RAN 170 may include other devices and additional access nodes.

The environment 100 also includes wireless device 120 which may be an end-user wireless devices such as a smart phone and may operate within one or more coverage areas 115, 116. The wireless device 120 may communicate over a wireless link 125 with the access node 110a or over a wireless link 135 with the access node 110b. The wireless links 125 and 135 may be or include, for example, a 5G NR and/or 4G LTE communication link.

However, the wireless device 120, despite being in two different coverage areas 115 and 116, may be in a coverage gap 140. The coverage gap 140 may occur due to any number of factors, including, for example, congestion, interference, tall buildings, tunnels, or other obstructions. Although only one coverage gap 140 is shown, multiple coverage gaps may exist in any coverage area.

The environment 100 may further include a coverage gap detection system 300, which is illustrated as operating in conjunction with the core network 102. Alternatively, the coverage gap detection system 300 may be an entirely discrete component, such as a processing node and may be incorporated in or in communication with the core network 102.

The coverage gap detection system 300 accesses a GMLC 103 within the core network 102. When making emergency calls, wireless device 120 is directed to a particular access node 110a or 110b. For example, in the illustrated scenario, because the wireless device 120 is in a coverage gap 140, its emergency call may be directed to the access node 110b and thus the location of the access node 110b is the initial location. Further, the wireless device 120 may push its position or location data to the access node 110b. The GMLC 103 may store both the initial location of the access node 110b as well as the updated location of the wireless device 120. The coverage gap detection system 300 access the initial location and the updated location for the emergency call made by wireless device 120 from the GMLC 103. Based on the data collected from the GMLC 103, the coverage gap detection system 300 may use stored algorithms to determine whether the wireless device 120 is located in a coverage gap 140.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 120. Wireless network protocols can comprise MBMS, code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

The core network 102 includes core network functions and elements. The core network 102 may have an evolved packet core (EPC) or may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QoS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 120 and is responsible for handling connection and mobility management tasks. The core network 102 may further include the GMLC 103 storing emergency call data.

The IMS network 104 is a standards-based architectural framework for delivering multimedia communications services such as voice, video and text messaging for mobile devices over IP networks. The IMS network 104 can be decomposed into distinct application, control, and transport layers with standardized interfaces and may enable secure multimedia communications between diverse devices across diverse networks.

Communication links 106, 107, and 108 can use various communication media, such as air, space, metal, optical fiber, or some other signal propagation path, including combinations thereof. Communication links 106, 107, and 108 can be wired or wireless and use various communication protocols. Communication links 106, 107, and 108 can be direct links or might include various equipment, intermediate components, systems, and networks, such as a cell site router, etc. Communication links 106, 107, and 108 may comprise many different signals sharing the same link.

The RAN 170 may include various access network systems and devices such as access nodes 110a and 110b. The RAN 170 is disposed between the core network 102 and the end-user wireless devices 120. Components of the RAN 170 may communicate directly with the core network 102 and others may communicate directly with the end user wireless devices 120. The RAN 170 may provide services from the core network 102 to the end-user wireless device 120.

The RAN 170 includes at least the access nodes or base stations 110a and 110b such as an eNodeB or gNodeB communicating with the wireless device 120. It is understood that the disclosed technology may also be applied to communication between an end-user wireless device and other network resources, such as relay nodes, controller nodes, antennas, etc. Further, multiple access nodes may be utilized. For example, some wireless devices may communicate with an LTE eNodeB and others may communicate with an NR gNodeB.

Access nodes 110a and 110b can be, for example, standard access nodes such as a macro-cell access node, a base transceiver station, a radio base station, an eNodeB device, an enhanced eNodeB device, a gNodeB in 5G New Radio (“5G NR”), or the like. The gNBs may include, for example, centralized units (CUs) and distributed units (DUs). Access nodes 110a and 110b can be configured to deploy one or more different carriers, utilizing one or more RATs. For example, a gNodeB may support NR and an eNodeB may provide LTE coverage. Any other combination of access nodes and carriers deployed therefrom may be evident to those having ordinary skill in the art in light of this disclosure.

The access nodes 110a and 110b can comprise a processor and associated circuitry to execute or direct the execution of computer-readable instructions to perform operations such as those further described herein. Access nodes 110a and 110b can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless device 120 may include any wireless device included in a wireless network. Wireless device 120 may be any device, system, combination of devices, or other such communication platform capable of communicating wirelessly with access network 170 using one or more frequency bands and wireless carriers deployed therefrom and further capable of communicating with the network 101. Each of wireless devices 120, may be, for example, an enhanced mobile broadband device (eMBB), a mobile phone, a wireless phone, a wireless modem, a personal digital assistant (PDA), a voice over internet protocol (VoIP) phone, a voice over packet (VOP) phone, or a soft phone, an internet of things (IoT) device, as well as other types of devices or systems that can send and receive audio or data. The wireless device 120 may be or include a high power wireless device or standard power wireless device. Other types of communication platforms are possible.

Environment 100 may further include many components not specifically shown in FIG. 1 including processing nodes, controller nodes, routers, gateways, and physical and/or wireless data links for communicating signals among various network elements. Environment 100 may include one or more of a local area network, a wide area network, and an internetwork (including the Internet). Environment 100 may be capable of communicating signals and carrying data, for example, to support voice, push-to-talk, broadcast video, and data communications by end-user wireless devices 120. Environment 100 may include additional base stations, controller nodes, telephony switches, internet routers, network gateways, computer systems, communication links, or other type of communication equipment, and combinations thereof.

Other network elements may be present in the environment 100 to facilitate communication but are omitted for clarity, such as public safety answering points (PSAPs), base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the access network 170 and the core network 102.

The methods, systems, devices, networks, access nodes, and equipment described herein may be implemented with, contain, or be executed by one or more computer systems and/or processing nodes. The methods described above may also be implemented as computer-readable instructions stored on a non-transitory computer readable medium. Many of the elements of communication environment100 may be, comprise, or include computers systems and/or processing nodes, including access nodes, controller nodes, and gateway nodes described herein.

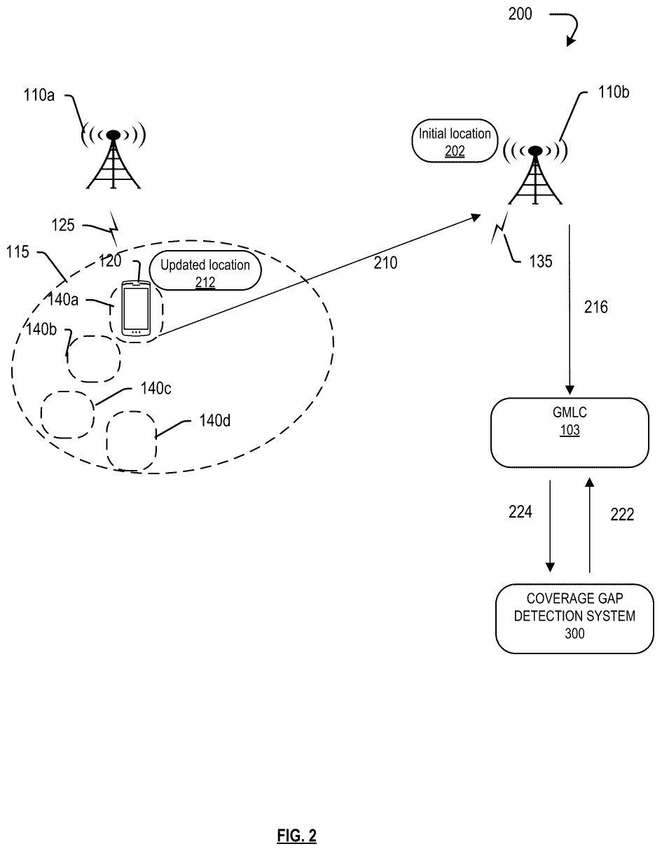

FIG. 2 is a workflow diagram 200 illustrating interaction of the coverage gap detection system 300 with the above-described environment. FIG. 2 illustrates the wireless device 120 positioned in a coverage hole 140a of a coverage area 115 deployed by access node 110a over the wireless link 125. Other coverage holes 140b, 140c, and 140d may also exist within the coverage area 115. These coverage holes 140a-140d may be due to many factors, including, but not limited to, tall buildings, tunnels, bodies of water, interference, congestion, or lack of wireless infrastructure.

The wireless device 120 triggers an emergency call at 210. However, because the wireless device 120 is in the coverage hole 140a, instead of going to the access node 110a, the emergency call is routed to the access node 110b over the wireless link 135 Accordingly, even though access node 110a is closer to the wireless device 120 than the access node 110b, the coverage hole 140a causes the call to be routed to the access node 110b, potentially resulting in poor quality of service due to a weak radio signal and mis-routing to an incorrect PSAP.

The access node 110b, which receives the emergency call, is defined as the initial location 202. Further, the wireless device 120 may push its location to the access node 110b. The location of the wireless device 120 is defined as the updated location 212. The updated location is optimally calculated within about thirty seconds and the best update location received in thirty seconds may be implemented as the updated location 212. The updated location 212 can typically be calculated with a high accuracy having a horizontal uncertainty under one hundred meters and even as little as ten meters using the GPS, GNSS, or DBH methods.

The access node 110b forwards the collected data to the GMLC 103 at 216. The GMLC 103 may store the collected data including the data identifying the initial location 202 and the updated location 212 in a database. In order to identify coverage holes of gaps, the coverage, the coverage gap detection system 300 queries the GMLC at 222 and receives the initial location 202 and the updated location 212 at 224. Using this data, the coverage gap detection system 300 can calculate a distance between the two locations, compare the distance to a threshold and determine whether a coverage gap exists based on the comparison. In response to determining a coverage gap exists, adjustments and modifications to the wireless network may be made by a carrier. These adjustments and modifications may include boosting signals, adding cell towers and equipment, and changing antenna patterns to improve connectivity in the coverage gap area.

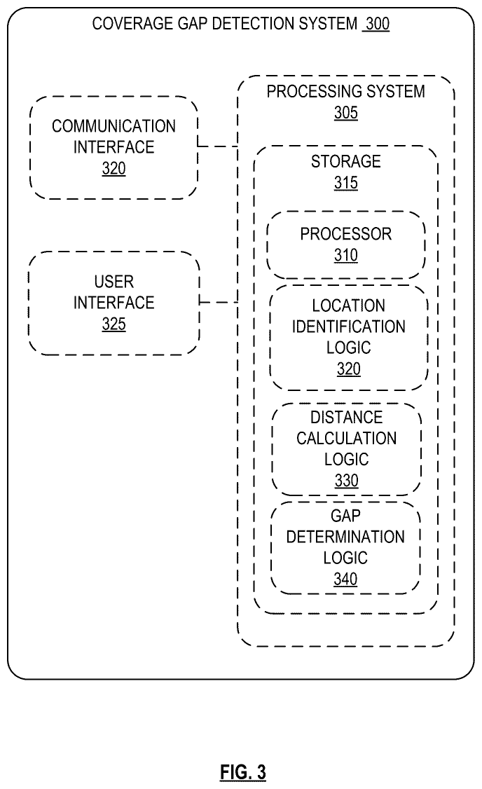

FIG. 3 illustrates further details of a coverage gap detection system 300, which may be configured to perform the methods and operations disclosed herein to identify coverage gaps within a wireless network. In the disclosed embodiments, the coverage gap detection system 300 may be integrated with the core network 102, the IMS network 104, or may be an entirely separate component, such as a processing node, capable of communicating with the core network and specifically the GMLC 103.

The coverage gap detection system 300 may be configured to retrieve location data from the GMLC 103. The coverage gap detection system 300 may identify the initial location and the updated location and determine a distance between the initial location and the updated location. The coverage gap detection system 300 may further compare the distance to a predetermined threshold. If the distance meets or exceeds the predetermined threshold, the coverage gap detection system 300 may determine that a potential coverage gap exists. To verify the existence of the coverage gap, the coverage gap detection system 300 may determine a number of times the coverage gap is detected during a predetermined time period. The coverage gap detection system may further compare the number of times to another predetermined threshold and determine that coverage gap exists in the updated location when the threshold is met or exceeded.

To provide an appropriate coverage gap determination, the coverage gap detection system 300 includes a processing system 305. Processing system 305 may include a processor 310 and a storage device or memory 315. Storage device 315 may include a disk drive, a flash drive, a memory, or other storage device configured to store data and/or computer readable instructions or codes (e.g., software). The computer executable instructions or codes may be accessed and executed by processor 310 to perform various methods disclosed herein. Software stored in storage device 315 may include computer programs, firmware, or other form of machine-readable instructions, including an operating system, utilities, drivers, network interfaces, applications, or other type of software. For example, software stored in storage device 315 may include one or more modules for performing various operations described herein. For example, location identification logic 320 may include instructions for retrieving and identifying an initial location and an updated location. Distance calculation logic 330 includes instructions for calculating the distance between the initial location and the updated location. Further, gap determination logic 340 may compare the calculated distance to a predetermined threshold. When the distance exceeds the threshold, the gap determination logic 340 may determine that a potential coverage gap exists. Further, the gap determination logic 340 may determine that a potential coverage gap has been detected multiple times at the updated location during a predetermined time period. Based on the number of times meeting another predetermined threshold, the gap determination logic 340 may verify the existence of a coverage gap at the updated location (i.e., the wireless device location).

Communication interface 320 may include hardware components, such as network communication ports, circuitry, devices, routers, wires, antenna, transceivers, etc. These components may, for example, receive requests from the wireless device 120, the access nodes 110a and 110b and the GMLC 103. User interface 325 may be configured to allow a user to provide input to the coverage gap detection system 300 and receive data or information from the coverage gap detection system 300. For example, a user may enter thresholds for distance and number of detection instances through the user interface 325. User interface 325 may include hardware components, such as touch screens, buttons, displays, speakers, etc. The coverage gap detection system 300 may further include other components such as a power management unit, a control interface unit, etc.

The coverage gap detection system 300 thus may utilize the memory 315 and the processor 310 to perform multiple operations. For example, the processor 310 may access stored instructions in the memory 315 to determine whether a potential coverage gap exists and to verify the existence of the potential coverage gap. The location of the coverage gap detection system 300 may depend upon the network architecture. For example, in smaller networks, a single coverage gap detection system 300 may be disposed for communication with the core network 102. However, in a larger network, multiple coverage gap detection systems 300 may be required to cover the network.

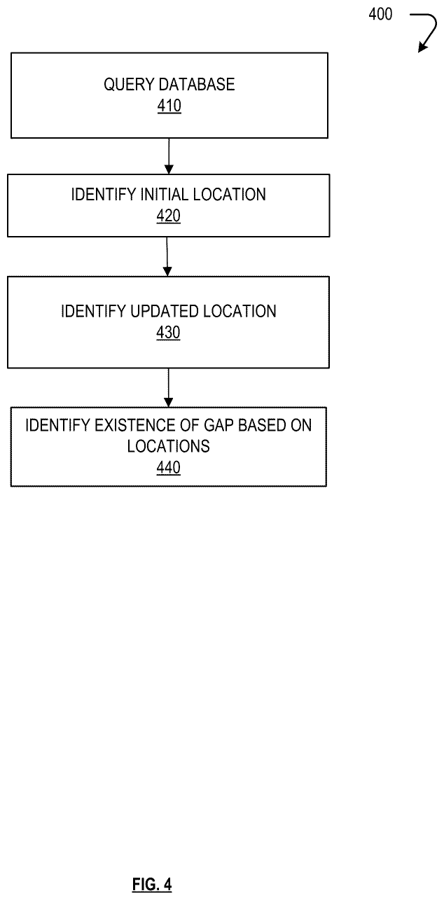

FIG. 4 illustrates an exemplary method 400 for coverage gap detection in accordance with embodiments described herein. Method 400 may be performed by any suitable processor discussed herein, for example, the processor 310 included in the coverage gap detection system 300. For discussion purposes, as an example, method 400 is described as being performed by the processor 310 of the coverage gap detection system 300.

Method 400 begins in step 410, when the coverage gap detection system 300 queries the GMLC 103. For example, the coverage gap detection system 300 may query a database of the GMLC 103 for location data collected during emergency calling. For example, an emergency call may originate from the wireless device 120 and emergency call data may be collected by the GMLC 103. In step 420, the coverage gap detection system 300 using processor 310 may identify initial location data. The initial location data may be reflective of the cell tower assigned to handle the emergency call. In step 430, the processor 310 may identify an updated location data reflective of the actual location of the wireless device 120 during the emergency call. The updated location may be the best updated location identified in a specific time period, e.g. thirty seconds. The “best” location is normally validated by the accuracy (e.g. horizontal uncertainty) and positioning method that was used to obtain the corresponding location. Per Federal Communications Commission (FCC) requirements, the updated 911 location should have horizontal accuracy under 100 m. With modern technology (e.g. GPS) the accuracy is normally around 15-30 m. Thus, the impacts on the gap detection by the horizontal accuracy of the best updated location can be neglected. Thus, the initial location and the updated location may be identified from stored emergency call records at the GMLC 103.

Finally, in step 440, the processor 310 identifies the existence of a coverage gap based on the identified locations. The existence of the coverage gap may be determined based on whether the distance between the initial location and the updated location meets or exceeds a configurable threshold. The threshold may be decided based on two factors. The first is the typical cell coverage range (radius) and the second is the possible maximum travel distance within the time period (e.g. 30 s). For the second factor, for example, assumed average highway driving speed is 100 km/h, a car with an emergency caller is moving with the average speed on highway, in 30 s from the time of call initiation, the maximum distance the car may move is around 833 m.

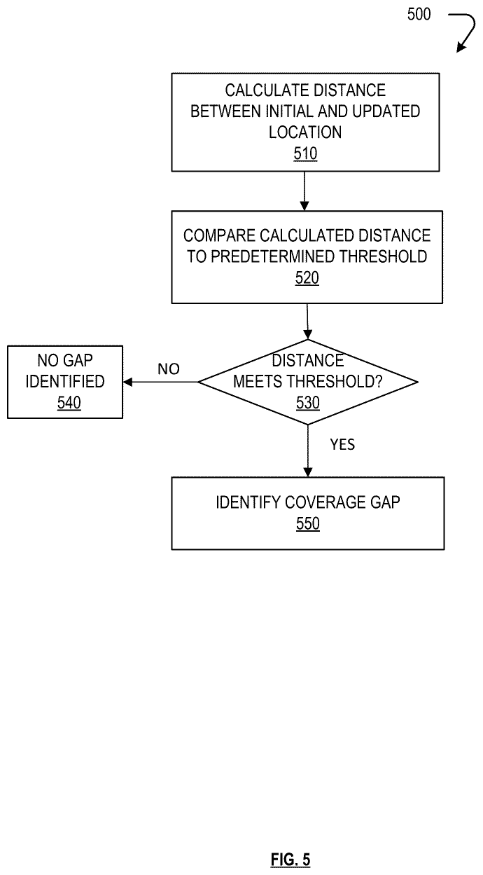

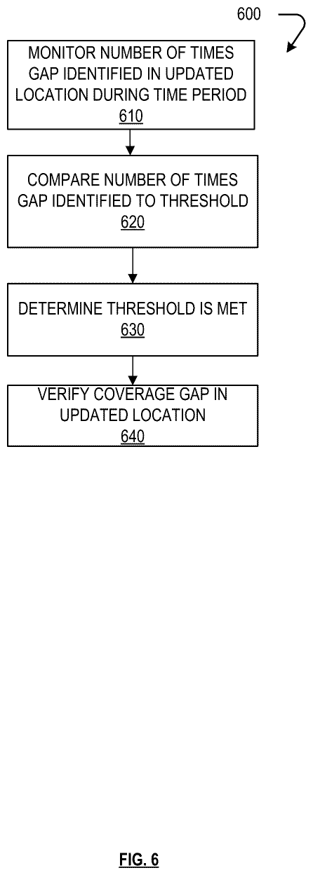

If multiple instances of distances exceeding the threshold are found for a specific geodetic location within certain time period, then the specific location may be considered as a radio coverage hole. The threshold may be adjusted based on the average radius of cell size for a specific market or area. Thus, as will be further described with respect to FIGS. 5 and 6, identification of the gap is based on the distance between the two locations identified as well as the frequency with which the updated location is identified as being associated with a potential gap.

FIG. 5 depicts a further exemplary method 500 for coverage gap detection in accordance with disclosed embodiments. Method 500 may be performed by any suitable processor discussed herein, for example, the processor 310 included in the coverage gap detection system 300. For discussion purposes, as an example, method 500 is described as being performed by the processor 310 of the coverage gap detection system 300.

Method 500 begins in step 510, when the coverage gap detection system 300 completes the identification of the initial and updated locations as described above with respect to FIG. 4. In step 510, the processor 310 calculates a distance between the initial location and the updated location. The following mathematical formula can be used to calculate the distance of two points with represented by longitude and latitude:

$$d = 2 r arcsin ( \sqrt{( {( sin ( \frac{Δ∅}{2} ) )}^{2} + cos ( {∅}_{1} ) cos ( {∅}_{2} ) {( sin ( \frac{Δ λ}{2} ) )}^{2} )} \qquad ( 1 )$$

In the above-referenced formula (1), “d” is the distance between the two points reflective of the initial location and the updated location. The symbol “r” is equal to the radius of the earth, which is approximately 6381 kilometers. The symbols ø₁ and ø₂ are the latitudes of the initial location point and the updated location point in radians. Δø is the difference in latitudes between the two points in radians. Finally, Δλ is the difference in longitudes between the two points in radians.

After calculating the distance in step 510, the processor 310 compares the calculated distance to a predetermined distance threshold in step 520. The predetermined distance threshold may be a configurable threshold. Thus, the configurable threshold may be set based upon the network architecture and is configurable based on network characteristics. In the illustrated scenario, the threshold may be, for example, 70 kilometers. Thus, for example, if the calculated distance from step 510 is 75 kilometers, then the distance meets or exceeds the threshold in step 530. If the threshold is met in step 530, the processor 310 identifies a coverage gap in step 550. However, if the distance between the initial location and the updated location does not meet the threshold in step 530, then no gap is identified in step 540.

FIG. 6 depicts a further exemplary method 600 for coverage gap detection in accordance with disclosed embodiments. Method 600 may be performed by any suitable processor discussed herein, for example, the processor 310 included in the coverage gap detection system 300. For discussion purposes, as an example, method 400 is described as being performed by the processor 310 of the coverage gap detection system 300.

The method begins in step 610, when the processor 310 monitors a number of times a gap is identified in the updated location within a predetermined time period and a location proximity range. The predetermined time period and location proximity range may be configurable. For example, the predetermined time period may be thirty seconds, five minutes, or twenty four hours or any other period of time appropriate for the network architecture. A proximity location range may be defined as 1 km radius appropriate for the network architecture. Thus, the method 600 may both follow and occur simultaneously with the methods 400 and 500.

At the end of the predetermined time period, the processor 310 may compare the number of times a potential gap is identified to a predetermined threshold in step 620. The predetermined threshold may also be configurable and may be, for example, three times, ten times, one hundred times, or some other number of times depending on the network architecture. The threshold number of times may be adjusted based on an average radius of cell size for a specific market or area. The identification of the potential gap occurs substantially as described above with respect to FIGS. 5 and 6.

In step 630, the processor 310 may determine that the threshold is met. For example, the processor 310 determines that the potential gap has been identified thirteen times during a predetermined twenty four hour period when the threshold number of times is ten times. Because thirteen times exceeds the threshold of ten times, the processor 310 determines that the threshold is met in step 630. Based on the fact that the threshold is met, the processor 310 verifies the existence of a coverage gap in the updated location in step 640. Accordingly, the processor 310 verifies the located potential coverage gap based on additional emergency call data

In some embodiments, methods 400, 500, and 600 may include additional steps or operations. Furthermore, the methods may include steps shown in each of the other methods. As one of ordinary skill in the art would understand, the methods 400, 500, 600 may be integrated in any useful manner and the steps may be performed in any useful sequence.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
identifying an initial location for an emergency call made by a wireless device;
identifying an updated location for the emergency call made by the wireless device;
determining a distance between the initial location and the updated location;
comparing the distance to a predetermined threshold; and
locating a potential coverage gap when the distance meets the predetermined threshold.

2. The method of claim 1, wherein the initial location and the updated location are identified from stored emergency call records.

3. The method of claim 1, wherein the initial location corresponds to a location of a serving cell for the emergency call.

4. The method of claim 3, wherein the initial location is a latitude and longitude of the serving cell.

5. The method of claim 1, wherein the updated location corresponds to a location of the wireless device.

6. The method of claim 4, wherein the updated location is determined based on one of global positioning system (GPS) and global navigation satellite system (GNSS) data.

7. The method of claim 4, wherein the updated location is determined based on a device based hybrid (DBH) method.

8. The method of claim 4, wherein the wireless device pushes data indicating the updated location to a gateway mobile location center (GMLC).

9. The method of claim 1, wherein the predetermined threshold is configurable based on network characteristics.

10. The method of claim 1, further comprising:
monitoring a number of times the potential coverage gap is identified at the updated location during a time period based on additional emergency call data;
comparing the number of times to an additional predetermined threshold; and
verifying existence of the coverage gap in response to the number of times meeting or exceeding the predetermined threshold.

11. A system comprising:
a memory storing data and instructions; and
a processor accessing the stored data and executing the stored instructions to perform operations including;
identifying an initial location for an emergency call made by a wireless device;
identifying an updated location for the emergency call made by the wireless device;
determining a distance between the initial location and the updated location;
comparing the distance to a predetermined threshold; and
locating a potential coverage gap when the distance meets the predetermined threshold.

12. The system of claim 11, wherein the initial location and the updated location are identified from stored emergency call records.

13. The system of claim 11, wherein the initial location corresponds to a location of a serving cell for the emergency call.

14. The system of claim 11, wherein the updated location corresponds to a location of the wireless device.

15. The system of claim 14, wherein the updated location is determined based on one of global positioning system (GPS) and global navigation satellite system (GNSS) data.

16. The system of claim 14, wherein the updated location is determined based on a device based hybrid (DBH) method.

17. A non-transitory computer-readable medium storing instructions executed by a processor to perform operations comprising:
identifying an initial location for an emergency call made by a wireless device;
identifying an updated location for the emergency call made by the wireless device;
determining a distance between the initial location and the updated location;
comparing the distance to a predetermined threshold; and
locating a potential coverage gap when the distance meets the predetermined threshold.

18. The non-transitory computer-readable medium of claim 17, wherein the initial location and the updated location are identified from stored emergency call records.

19. The non-transitory computer-readable medium of claim 17, wherein the initial location corresponds to a location of a serving cell for the emergency call and the updated location corresponds to a location of the wireless device.

20. The non-transitory computer-readable medium of claim 17, further comprising verifying the located potential coverage gap based on additional emergency call data.
